(19) United States
(12) Patent Application Publication
(10) Pub. No.: US 2026/0148507 A1
(43) Pub. Date: May 28, 2026

(54) MULTI-STAGE DIFFUSION MODEL DISTILLATION FOR AUGMENTED REALITY EXPERIENCES

(71) Applicant: Snap Inc., Santa Monica, CA (US)

(72) Inventors: Viktar Atliha, London (GB); Maksym Bekuzarov, London (GB); Ekaterina Deyneka, Irvine, CA (US); Andrey Alejandrovich Gomez Zharkov, Santa Monica, CA (US); Konstantin Gudkov, Playa Vista, CA (US); Amir Iagudin, London (GB); Viacheslav Ivanov, Los Angeles, CA (US); Fedor Kitashov, London (GB); Egor Nemchinov, London (GB); Polina Popenova, London (GB); Grigorii Sotnikov, Los Angeles, CA (US); Aleksei Zhuravlev, London (GB)

(21) Appl. No.: 18/963,035

(22) Filed: Nov. 27, 2024

(51) Int. Cl. G06T 19/00; G06N 20/00

(52) U.S. Cl. CPC G06T 19/006; G06N 20/00

(57) ABSTRACT

A system and method for generating augmented reality (AR) experiences are disclosed. The system generates source and target indications associated with an image transformation, and generates a first set of source images and first set of target images using a first trained machine learning (ML) model, the source indications, and the target indications. The system trains a second ML model to generate a target image corresponding to a source image based on the first set of source images and the first set of target images, and generates a second set of target images using the second trained ML model and a second set of source images. The system trains a third ML model to generate an additional target image corresponding to an additional source image based on the second set of source images and second set of target images, and generates an AR experience comprising the third trained ML model.

### TECHNICAL FIELD

The disclosed subject matter relates generally to the fields of machine learning (ML), image processing, and augmented reality (AR) technology. More specifically, but not exclusively, the disclosed subject matter relates to the distillation of diffusion models for the generation of near real-time, on-device AR experiences.

### BACKGROUND

The widespread adoption of mobile devices has driven increasing demand for near real-time content transformation capabilities. For example, users are increasingly seeking immersive AR experiences that can transform their personal photos (e.g., “selfies”) with artistic styles, apply creative visual effects to their camera feeds in near real-time, or enable interactive photo filters for content sharing and digital self-expression.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a diagrammatic representation of an interaction system for facilitating interactions over a network, according to some examples.

FIG. 2 is a diagrammatic representation of further details regarding the interaction system, according to some examples.

FIG. 3 is a diagrammatic representation of an AR experience generation system, according to some examples.

FIG. 4 is a flowchart illustrating a method for generating pairs of aligned source prompts and target prompts, according to some examples.

FIG. 5 is a flowchart illustrating a method for generating aligned image pairs, according to some examples.

FIG. 6 is a flowchart illustrating an AR experience generation method, according to some examples.

FIG. 7 is an illustration of a (source image, target image) pair, according to some examples.

FIG. 8 is an illustration of a (source image, target image) pair, according to some examples.

FIG. 9 is an illustration of image transformations and associated AR experiences, according to some examples.

FIG. 10 is an illustration of image transformations and associated AR experiences, according to some examples.

FIG. 11 is an illustration of image transformations and associated AR experiences, according to some examples.

FIG. 12 is a schematic diagram illustrating data structures that may be stored in a database of the interaction server system, according to some examples.

FIG. 13 is a schematic diagram illustrating a structure of a message, according to some examples.

FIG. 14 is a diagrammatic representation of a machine, according to some examples, within which instructions for causing the machine to perform any one or more of the methodologies discussed herein may be executed.

FIG. 15 is a diagrammatic representation of a software architecture, according to some examples, which can be installed on any one or more of the devices described herein.

FIG. 16 is a block diagram showing an ML program, according to some examples.

### DETAILED DESCRIPTION

Driven by the widespread adoption of mobile devices, many applications see increasing demand for near real-time content transformation capabilities. For example, there is growing interest in enabling immersive AR experiences that can instantly or near instantly modify single images or camera feeds using artistic styles or visual effects. Some AR experience generation solutions rely on image translation and/or image generation models such as diffusion models. Diffusion models are powerful general-purpose ML models that can be used to create visual representations in arbitrarily complex styles. However, diffusion models are stochastic and may struggle to achieve consistent stylization results, leading to the use of auxiliary models to increase control over image generation outputs. Furthermore, diffusion models have high computational and space requirements, making them difficult or impractical to use on mobile devices or on other devices with limited computational power (or with storage space constraints).

Thus, many technical challenges remain. Near real-time inference using diffusion models on mobile devices or edge devices remains a technically challenging problem. One technical challenge is how to configure a system to generate AR experiences that process images or camera feeds based on a desired image transformation or style, the processing being performed in near real-time on a device with limited computational and/or storage resources. Furthermore, it is technically challenging to ensure that the generated AR experiences consistently perform high-quality transformations of input images, preserving key structure of input images while adjusting or altering image aspects as required by the style or transformation of interest.

Examples in the disclosure herein provide an AR experience generation system that addresses or alleviates the technical problems above by using a multi-stage process. The multi-stage process starts with a general-purpose image generation pipeline and/or includes the generation of one or more specialized models, each specialized model corresponding to an image transformation of interest and/or able to run on a device as part of an automatically generated AR experience. In some examples, the multi-stage process includes a multi-stage distillation process that maps the general-purpose image generation pipeline to a faster and/or more compact image-to-image translation model, which is in turn used to generate a specialized, mobile-friendly image-to-image translation model with even more modest inference-time requirements and/or space requirements. The multi-stage process can include image space modification and/or enhancement operations that enable improved quality and/or consistency of the application of transformations of interest to input images to obtain output images with a desired style, artistic effect, and so forth. For example, in the case of images of faces, the output images exhibit the desired style or artistic effect while preserving key facial features in the input images.

In some examples, the AR experience generation system accesses a set of image transformations of interest such as image processing effects (e.g., stylization effects, artistic style transformation effects, and so forth). Each image transformation can be associated with one or more image transformation indications, such as a natural language (NL) description, or a set of reference images illustrating the effects of the image transformation, such as a desired image style, and so forth. Given an image transformation of interest and an associated image transformation indication, the AR experience generation system can generate a set of source indications and a set of target indications. The AR experience generation system can access a set of image attributes and/or generate a set of image attribute values corresponding to the set of image attributes. The AR experience generation system can generate the set of source indications using the set of image attributes and the set of image attribute values. Given the set of source indications and the image transformation indication, the system can generate the set of target indications.

In some examples, the AR experience generation system accesses a pre-trained image generation pipeline, such as a text-to-image diffusion pipeline. Given the set of source indications and the set of target indications, the AR experience generation system uses the text-to-image diffusion pipeline to generate a first set of source images and first set of target images using the pre-trained image generation pipeline. In some examples, the AR experience generation system implements one or more procedures for enhancing the alignment of each source image with each corresponding target image. For example, the AR experience generation system generates a sample source image using the pre-trained image generation pipeline and uses it to extract a set of image aspects that will be used as conditions in subsequent generation steps. The system generates an initial source image using the pre-trained image generation pipeline, a source indication, extracted image aspects, and/or a noise tensor. The system further generates an initial target image using the pre-trained image generation pipeline, a target indication corresponding to the source indication, the same extracted image aspects, and/or the same noise tensor used in generating the initial source image. In some examples, the system post-processes the generated sets of source images and target images via operations such as a color correction operation, landmark adjustment operation, a diffusion pass operation, and so forth.

In some examples, the AR experience generation system trains an intermediate image-to-image translation model using the first set of source images and the first set of target images. The intermediate image-to-image translation model can correspond to an image-to-image diffusion model enabled to execute instruction-based image editing. The AR experience generation system can access a set of real images representing a second set of source images, and generate a second set of target images by running the intermediate image-to-image translation model on each image in the second set of source images.

In some examples, the AR experience generation system trains a mobile-friendly specialized image-to-image translation model using the second set of source images and the second set of target images. The specialized image-to-image translation model can be or include, for example, a fully convolutional neural network (CNN).

In some examples, the AR experience generation system generates an AR experience comprising the trained specialized image-to-image translation model. The AR experience can be deployed to one or more client devices of one or more types (e.g., mobile devices, edge devices, etc.). In some examples, the AR experience can correspond to a digital effect, modifier, filter, augmentation, or the like, that is made available on the client device (e.g., a mobile device running an interaction application that provides access to the AR experience).

In some examples, the AR experience generation system described herein implements a multi-stage technical process that first distills an implementation of an image transformation that uses a general-purpose image generation pipeline into a more efficient implementation relying on an image-to-image translation model, and then further distills it into a transformation-specific, mobile-friendly image-to-image translation model with reduced computational demands. In some examples, the AR experience generation system uses image space modification operations and/or enhancement procedures that enable high-quality, consistent transformations while preserving key structural elements of input images. Thus, the AR experience generation system can generate near real-time or real-time AR experiences that can be executed on a variety of devices, such as a mobile phone of a user of an interaction application as described herein. The resulting AR experiences allow users to transform content, such as image data in camera feeds and/or other images nearly instantly into output feeds and/or images in a variety of styles while obtaining consistently high-quality results.

### Networked Computing Environment

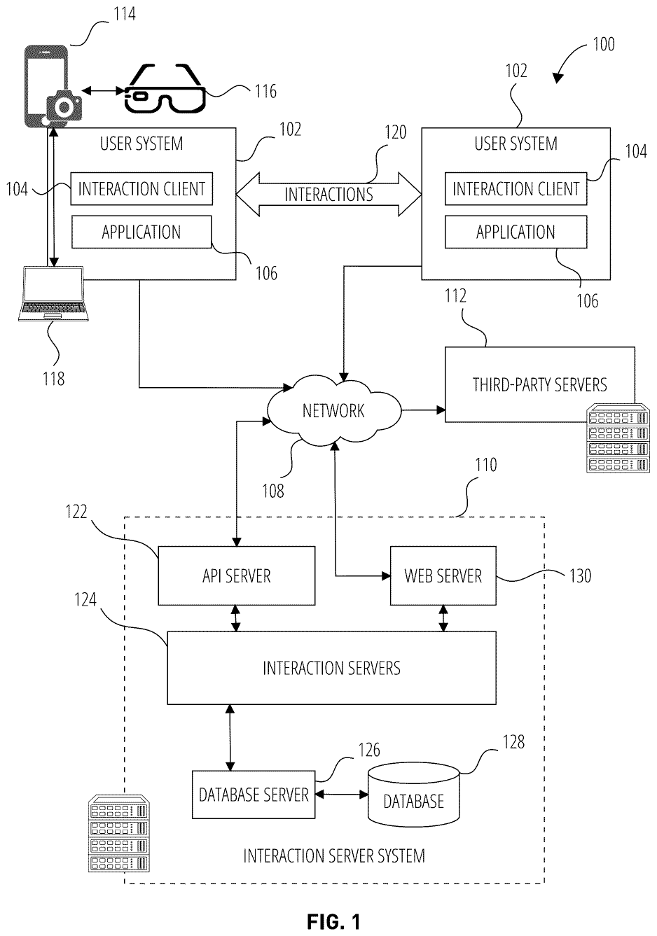

FIG. 1 is a block diagram showing an example interaction system interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Application Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Programming Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 1210); the location of friends within an entity relationship graph; and opening an application event (e.g., relating to the interaction client 104).

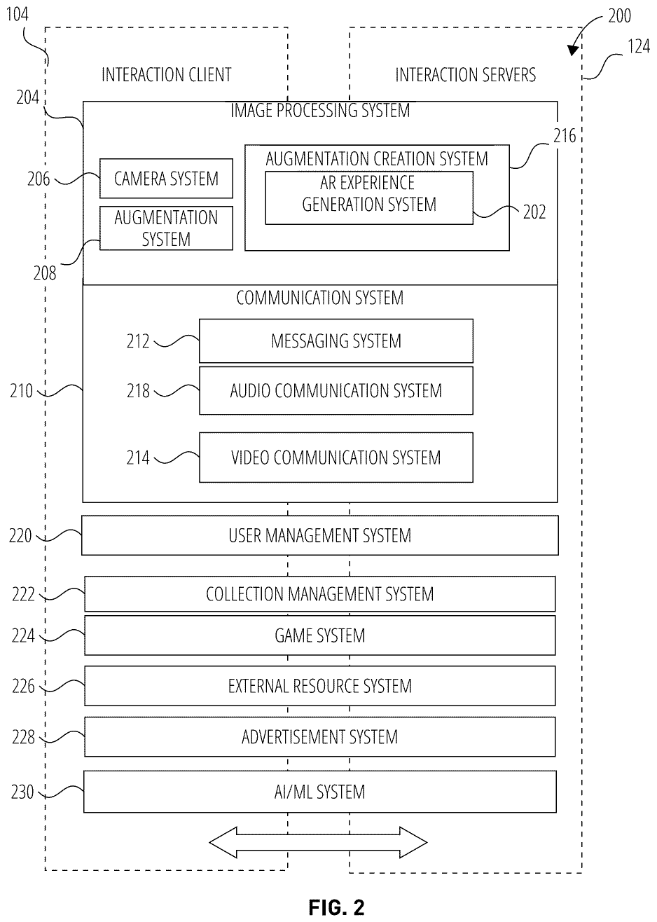

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

FIG. 2 is a diagrammatic representation 200 of further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 204 provides various functions that enable a user to capture and augment (e.g., annotate or otherwise modify or edit) media content associated with a message.

A camera system 206 includes control software (e.g., in a camera application) that interacts with and controls hardware camera hardware (e.g., directly or via operating system controls) of the user system 102 to modify and augment real-time images captured and displayed via the interaction client 104.

The augmentation system 208 provides functions related to the generation and publishing of augmentations or digital effects (e.g., media overlays, etc.) for images captured in real-time by cameras of the user system 102 or retrieved from memory of the user system 102. For example, the augmentation system 208 operatively selects, presents, executes and/or displays augmentations or digital effects (e.g., media overlays such image filters, image lenses, modifications, etc.) to the interaction client 104 for the modification of real-time images (or near real-time images) received via the camera system 206 or stored images retrieved from a memory of a user system 102. These augmentations or digital effects are selected by the augmentation system 208 and presented to a user of an interaction client 104, based on a number of inputs and data, such as for example:
Geolocation of the user system 102; and
Entity relationship information of the user of the user system 102.

An augmentation or digital effect (e.g., such as an AR experience) may include audio content, visual content, audio effects, visual effects, multimedia effects, and so forth. Examples of audio and/or visual content include pictures, texts, logos, animations, and sound effects. Examples of visual effects include color overlaying, media overlays, image transformations (e.g., according to specific style or desired target domain, etc.), and so forth. The audio content, visual content and/or audio/visual/multimedia effects can be applied to a media content item (e.g., a photo or video) at user system 102 (e.g., at mobile device 114, computer client device 118, head-wearable apparatus 116, and so forth) for communication in a message, or applied to content items and/or a content stream or feed transmitted from an interaction client 104 (e.g., a video stream, etc.). As such, the image processing system 204 may interact with, and support, the various subsystems of the communication system 210, such as the messaging system 212 and the video communication system 214.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 204 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 204 provides a user-based publication platform that enables users to select a geolocation on a map and upload content associated with the selected geolocation. The user may also specify circumstances under which a particular media overlay should be offered to other users. The image processing system 204 generates a media overlay that includes the uploaded content and associates the uploaded content with the selected geolocation.

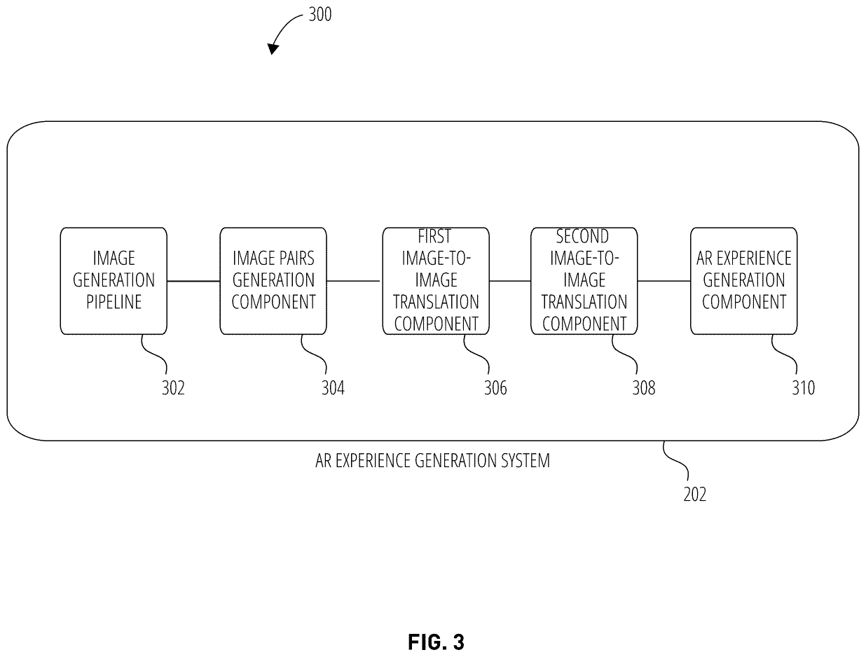

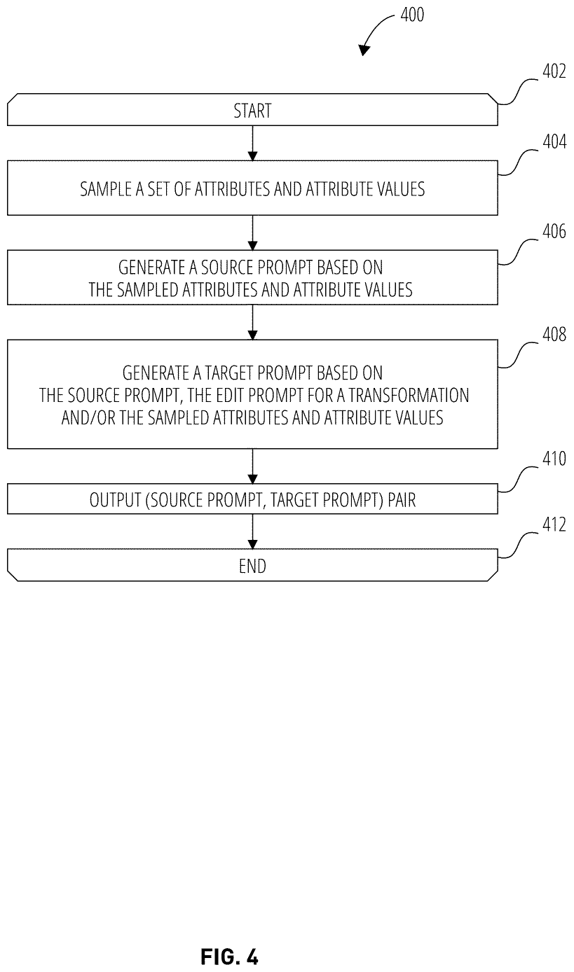

The augmentation creation system 216 supports augmented reality developer platforms and includes one or more applications for content creators (e.g., artists, developers, etc.) to create and publish augmentations or digital effects (e.g., audio and visual augmentations, visual effects, AR experiences, etc.) of the interaction client 104. The augmentation creation system 216 provides a library of built-in features and tools to content creators including, for example custom shaders, tracking technology, and templates. The augmentation creation system 216 can include an AR experience generation system 202 (see at least FIG. 2, FIG. 3 and FIG. 4 of the present disclosure for details). The AR experience generation system 202 can be used, for example, by a software developers and/or content creators (e.g., an AR experience developer, an artist, a marketer, etc.) to automatically generate an AR experience as part of an AR experience bundle that can be shared, for example, with one or more users of an interaction (e.g., messaging) application platform, and so forth. As referred to herein, an AR experience refers, for example, to a digital effect involving a set of AR elements that are animated, anchored to specific positions, overlaid onto, or otherwise used to modify one or more real-time, near real-time or stored images or videos. The set of AR elements can include visual content and/or visual effects, audio content and/or audio effects, multimedia content and/or effects, and so forth. Examples of audio and visual content include virtual objects and/or animations, pictures, texts, logos, animations, sound effects, and so forth. Examples of visual effects include color overlaying, media overlays image transformations (e.g., according to a specific style or desired target domain, etc.), and so forth.

In some examples, an AR experience bundle (or AR bundle) represents a set of AR elements (e.g., standard AR elements and/or linked AR elements, etc.) and/or corresponding code that indicates the visual appearance, interaction, and/or behavior of each of the AR elements. In some examples, the AR bundle includes the code necessary for a device to launch and execute the AR experience associated with the AR bundle. In some examples, such devices include a computer client device 118, a mobile device 114, a head-wearable apparatus 116, an edge device, additional or alternative user devices or computing devices, and so forth. In some examples, an indicator can be presented on an application featuring the automatically created AR experience bundle. In response to receiving selection of the indicator, the automatically created AR experience bundle is launched and/or used to modify one or more real-time or stored images or videos. For example, when the AR experience is launched or accessed on a mobile device 114, the AR elements of the AR experience are overlaid on top of a real-time image captured by the mobile device 114, or are otherwise and/or additionally used to transform the real-time image captured by the mobile device 114. In some examples, the AR elements are modified or behave in a manner corresponding to events or triggers associated with the AR experience bundle. In some examples, the launching the AR experience corresponds to modifying an input image with respect to a user selected image transformation and/or style, as further detailed with reference to FIG. 3. For example, a user image can be automatically converted from a photo-realistic style to a desired artistic style, such as Pixel Art, Impressionist style, the style of a specific artist, and so on. The transformed or converted user image can then be shared with one or more users of an interaction (e.g., messaging) application platform or of the interaction system 100. In some examples, the sharing of the transformed or converted user image can be executed automatically based on a pre-determined list of user contacts and/or a pre-existing conversation or message interaction. In some examples, upon the interaction system 100 or interaction application platform receiving a share request from a user, the interaction system 100 or interaction application platform presents the user with a list of contacts and/or conversations, and upon receiving a follow-up contact or conversation selection, shares the transformed or converted user image with the selected contact(s) and/or conversation(s).

In some examples, the augmentation creation system 216 provides a merchant-based publication platform that enables merchants to select a particular augmentation associated with a geolocation via a bidding process. For example, the augmentation creation system 216 associates a media overlay of the highest bidding merchant with a corresponding geolocation for a predefined amount of time.

A communication system 210 is responsible for enabling and processing multiple forms of communication and interaction within the interaction system 100 and includes a messaging system 212, an audio communication system 218, and a video communication system 214. The messaging system 212 is responsible for enforcing the temporary or time-limited access to content by the interaction clients 104. The messaging system 212 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 218 enables and supports audio communications (e.g., real-time audio chat) between multiple interaction clients 104. Similarly, the video communication system 214 enables and supports video communications (e.g., real-time video chat) between multiple interaction clients 104.

A user management system 220 is operationally responsible for the management of user data and profiles, and maintains entity information (e.g., stored in entity tables 1208, entity graphs 1210 and profile data 1202) regarding users and relationships between users of the interaction system 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system (not shown) provides various geographic location (e.g., geolocation) functions and supports the presentation of map-based media content and messages by the interaction client 104. For example, an example map system enables the display of user icons or avatars (e.g., stored in profile data 1202) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 204 and the camera system 206 to analyze images and extract information such as objects, text, or faces. This information can then be used by the image processing system 204 to enhance, filter, transform or manipulate images. The artificial intelligence and machine learning system 230 may be used by the augmentation system 208, augmentation creation system 216 or AR experience generation system 202 to generate augmentations or digital effects that may include AR experiences such as adding virtual objects or animations to real-world images, transforming images (e.g., with respect to a desired and/or selected image transformation, artistic style and/or visual effect, etc.), and so forth. The communication system 210 and messaging system 212 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 218 to provide speech recognition and natural language processing capabilities, allowing users to interact with the interaction system 100 using voice commands.

### AR Experience Generation System

FIG. 3 is a diagrammatic representation 300 of an AR experience generation system 202, according to some examples. The AR experience generation system 202 includes one or more of at least an image generation pipeline 302, an image pairs generation component 304, a first image-to-image translation component 306, a second image-to-image translation component 308, and an AR experience generation component 310. In some examples, the AR experience generation system 202 can include one or more user interfaces (UIs), associated for example with one or more of the system components, as further described below. In some examples, one or more of the components of the AR experience generation system 102 and/or their outputs are deployed to, executed at, or received from a server (e.g., one of the interaction servers 124 or another server of the interaction system 110, etc.). In some examples, one or more of the components of the AR experience generation system 102 and/or their outputs are deployed to, executed at, or received from a user system 102 (e.g., a mobile device 114, head-wearable apparatus 116, computer client device 118, and so forth).

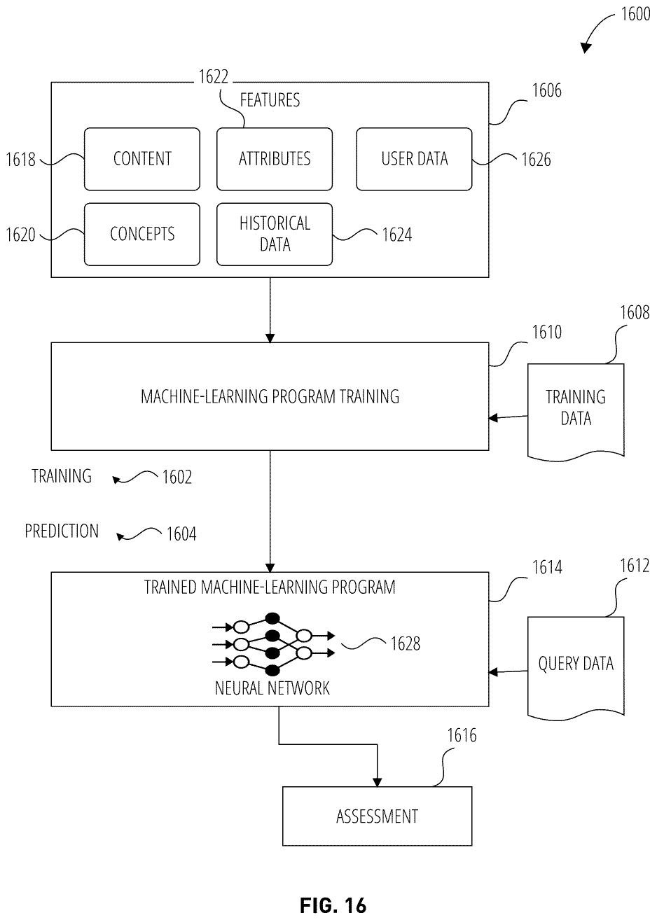

In some examples, the image generation pipeline 302 corresponds to an text-to-image diffusion pipeline for image generation that includes a text-to-image diffusion model and/or auxiliary control mechanisms that increase control and/or customization capabilities for generated images (see, e.g., the discussion with reference to FIG. 16 for more details). In some examples, the image generation pipeline 302 comprises one or more of a speech-to-image diffusion pipeline, a multi-modal pipeline that combines multiple input types (e.g., text+image, audio+text, etc.) to generate images with more precise control over the output, and so forth. Throughout the rest of this disclosure, the image generation pipeline 302 is discussed as a text-to-image diffusion pipeline as a representative example only.

In some examples, the AR experience generation system 202 uses image pairs generation component 304 to generate and/or sample aligned image pairs based on the image generation pipeline 302. The AR experience generation system 202 receives or accesses a set of transformations corresponding, for example, to image transformations or image processing effects such as stylization effects, artistic style transformation effects, and so forth. Each transformation can be characterized by an indication associated with the transformation. In some examples, an image transformation indication can take the form of a NL description or NL prompt (e.g., an edit prompt) that describes a representative style, attribute, or character of the transformation: “Pixel Art,” “Impressionist Style,” “Expressionism,” “English Renaissance,” and so forth. In some examples, an image transformation indication can take the form of a set of reference images representative of the effects of the transformation (e.g., example images in a desired style, etc.). In some examples, the AR experience generation system 202 accesses a pre-determined set of transformations and/or corresponding indications including edit prompts and/or reference images chosen or curated, for example, by domain experts such as creative professionals, among others. The pre-determined set of transformations can incorporate, in some examples, thousands of transformations of interest, allowing the AR experience generation system 202 to eventually generate thousands of compelling AR experiences.

Given a transformation of interest, characterized by a transformation indication such as an edit prompt, the image pairs generation component 304 can use the image generation pipeline 302 to generate a set of (source image, target image, edit prompt) tuples, or a corresponding set of (source image, target image) pairs for the edit prompt. In some examples, each source image corresponds to a photorealistic-style image, and each target image corresponds to a version of source image content that reflects the transformation of interest, as characterized by the edit prompt.

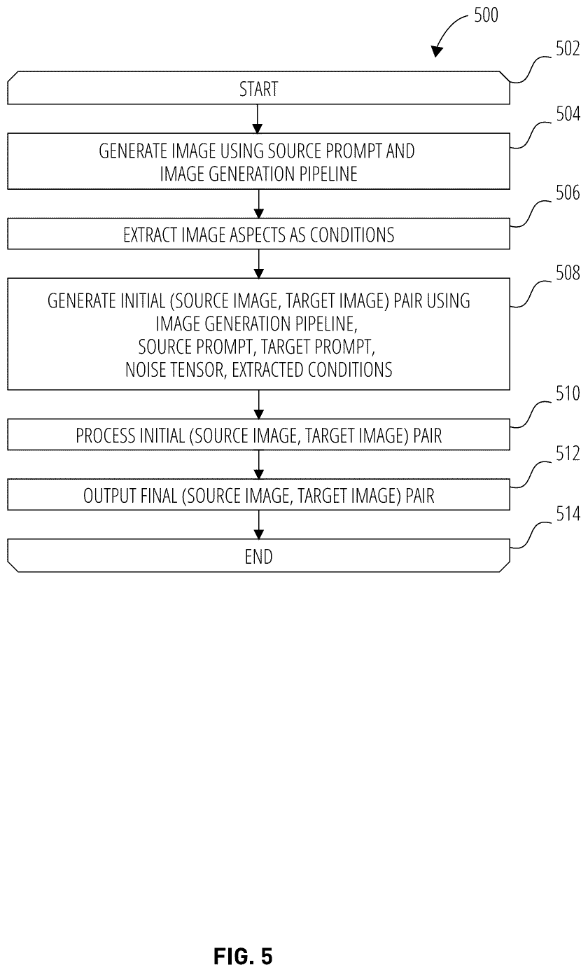

Text-guided generation of aligned image pairs for a target transformation. In some examples, the image pairs generation component 304 can use a text-guided generation procedure to generate the set of (source image, target image pairs) given an edit prompt for a transformation of interest. Given the edit prompt, the image pairs generation component 304 can generate a (source prompt, target prompt) pair (see, e.g., FIG. 4 for further details). Given the (source prompt, target prompt) pair, the image pairs generation component 304 can use the image generation pipeline 302 to generate (source image, target image) pairs. The image pairs generation component 304 can apply one or more post-processing operations and/or procedures in order to further enhance the alignment of each source image and corresponding target image in the context of the target transformation. FIG. 5 further details the process of text-guided generation of aligned image pairs based on an available image generation pipeline 302.

Image-guided generation of aligned image pairs for a target transformation. In some examples, given an edit prompt for the transformation of interest, the image pairs generation component 304 first uses an image generation pipeline to generate a set of reference images corresponding to the edit prompt. These images individually and/or collectively capture a visual style and/or transformation details associated with the transformation of interest, while including a variety of scenes or objects. The image generation pipeline used to generate the reference images can be the image generation pipeline 302, represented for example by a text-to-image diffusion pipeline. In some examples, a different image generation pipeline and/or underlying base image generation model or collection of models can be used. In some examples, the set of reference images have been previously generated and/or curated, and are provided to and/or received by the image generation component 304. Given the set of reference images, the image pairs generation component 304 can use them to train a low-rank domain adaptation (LoRA) model. The image pairs generation component 304 can generate a source prompt (as detailed, for example in FIG. 4), generate a source image using the image generation pipeline 302 and the source prompt, and then generate a target image by transforming the source image using the trained LoRA model.

In some examples, the image pairs generation component 304 and/or image generation pipeline 302 are deployed to and/or executed by one or more of the components of the interaction server system 110 (e.g., a server as in interaction servers 124, etc.). In some examples, the image pairs generation component 304 and/or the image generation pipeline 302 can be executed by a computer client device 118. In some examples, the outputs of the image generation component 304 and/or image generation pipeline 302 can be stored and/or used locally (e.g., at the interaction server system 110, computer client device 118), or can be transmitted to another system (e.g., to a (second) client device 118, user system 102, interaction server system 110, etc.), or to another component of the same system (e.g., from a server of the interaction server system 110 to another server of the interaction server system 110, etc.).

Given one or more transformations, each associated with a transformation indication such as an edit prompt and with a set of aligned image pairs, the AR experience generation system 202 uses a first image-to-image translation component 306 to train an image-to-image translation model using the sets of pairs of aligned images and the edit prompts corresponding to the one or more target transformations. In some examples, the image-to-image translation model is an image-to-image diffusion model enabled to perform instruction-based image editing (see, e.g., the discussion with reference to FIG. 16 for more details). The training of the image-to-image diffusion model corresponds to a first distillation stage associated with the one or more target transformations given the initial text-to-image diffusion pipeline. Given (source image, target image, edit prompt) tuples, each source image and/or edit prompt are used as inputs during the training of the image-to-image diffusion model, while each corresponding target image is used as the ground truth output.

In some examples, the first image-to-image translation component 306 trains an image prompt adapter (IP-Adapter) model as an auxiliary model to the image-to-image diffusion model. Such an IP-Adapter model is convenient, for example, when the transformation of interest is more accurately, easily or comprehensively characterized by a visual representation than by a NL description. Given a transformation of interest and corresponding edit prompt, the first image-to-image translation component 306 can construct a set of reference images for the transformation of interest by sampling images from the output of a text-to-image diffusion pipeline that uses the edit prompt as input. In some examples, the text-to-image diffusion pipeline can be the image generation pipeline 302 above. The first image-to-image translation component 306 can then sample random source images and train the image-to-image diffusion model to reconstruct corresponding target images while using the set of generated reference images illustrating or being representative of the target transformation.

In some examples, while the text-to-image diffusion pipeline and/or model corresponding to the image generation pipeline 302 can be general purpose, the image-to-image diffusion model corresponding to the first image-to-image translation component 306 is trained on (source image, target image) data generated for a set of edit prompts corresponding to a set of pre-determined transformations. The resulting trained image-to-image diffusion model may have enhanced image translation performance for the transformations of interest with respect to the text-to-image diffusion model and/or pipeline represented by the image generation pipeline 302. The trained image-to-image diffusion model may have a reduced size and/or inference time computational requirements with respect to the text-to-image diffusion model and/or pipeline. The trained image-to-image diffusion model may also have lower hallucination rates across the transformations of interest. As indicated above, the image-to-image diffusion model can perform instruction-based image editing. In some examples, the instructions can be provided by a user via a user interface (UI) associated with the image-to-image diffusion model, as part of a UI for the AR experience generation system 202. The image-to-image diffusion model can include a built-in text encoder that enables the trained image-to-image diffusion model to process instructions it did not see during training. Thus, the trained image-to-image diffusion model can be used as a teacher model for student models corresponding to smaller, specialized image-to-image translation models able to run on a variety of devices with a variety of resource profiles, as further described below. In some examples, the first image-to-image translation component 306 is executed by one or more of the components of the interaction server system 110 (e.g., the API server 122, interaction servers 124). In some examples, the corresponding intermediate image-to-image translation model (e.g., the image-to-image diffusion model) is received from, deployed to, trained at and/or executed by the respective one or more of the components of the interaction server system 110 (e.g., a server of the interaction server system 110, etc.). In some examples, the first image-to-image translation component 306 is received from, deployed to, trained at and/or executed by a computer client device 118 (e.g., at a user system 102). In some examples, the corresponding intermediate image-to-image translation model (e.g., the image-to-image diffusion model) can be received from, deployed to, trained at and/or executed by a computer client device 118 (or otherwise at a user system 102). In some examples, the outputs of the first image-to-image translation component 306 and/or the trained image-to-image diffusion model can be stored locally (e.g., at the interaction server system 110, user system 102, computer client device 118, etc.) and/or transmitted to another system (the interaction server system 110, user system 102, computer client device 118, etc.) or another component of the same system.

Given a transformation of interest of the set of transformations and the trained image-to-image diffusion model generated by the first image-to-image translation component 306, the second image-to-image translation component 308 trains a specialized image-to-image translation model dedicated to performing the transformation of interest. The operations of the second image-to-image translation component 308 thus correspond to a second distillation stage associated with the set of transformations of interest. In some examples, the trained image-to-image diffusion model acts as a teacher model in a teacher-student distillation scenario, with the specialized image-to-image translation model acting as the student model. The second image-to-image translation component 308 runs the trained image-to-image diffusion model on a set of real images, using as input a transformation indication associated with the transformation to be executed by the trained image-to-image diffusion model (e.g., a NL prompt, a set of reference images, etc.). The second image-to-image translation component 308 further specifies a set of values for one or more parameters of the trained image-to-image diffusion model, such as a number of inference steps, indicators of relative importance associated with input text or an input image (e.g., text guidance scale, image guidance scale), amount of noise to add to an input image (e.g., a strength parameter), and so forth. In some examples, the parameter values are determined based on user input received via the UI of the trained image-to-image diffusion model. Given the transformation of interest and a real image in the set of real images, the trained image-to-image diffusion model generates a transformed output image. Given a set of sampled (real image, transformed output image) pairs, the second image-to-image translation component 308 can elicit and/or receive user feedback with respect to the quality of one or more of the pairs via the UI of the trained image-to-image diffusion model or via an additional evaluation UI. The second image-to-image translation component 308 can automatically analyze the user feedback to determine if one or more quality measures associated with the set of sampled image pairs satisfy one or more predetermined criteria.

In some examples, each (real image, transformed output image) pair can be associated with a rating scale (e.g., from a MIN value to a MAX value, etc.) for a pre-selected quality measure, such as for example perceived quality of the transformation of the real image into the transformed output image. The second image-to-image translation component 308 can elicit via the UI user feedback in the form of a selected rating value. Alternatively, the image pair can be associated with a visual element indicating a Boolean valued attribute corresponding to the perceived quality of the transformation (e.g., “Acceptable image pair: (Y/N),” or equivalent). In some examples, a value of a quality measure associated with the set of sampled (real image, transformed output image) pairs can be computed as a summary statistic based on quality measure values for some or all of the sampled image pairs (e.g., median perceived quality, weighted average of ratings, etc.). In some examples, the second image-to-image translation component 308 can determine that a value of a quality measure associated with the set of sampled image pairs meets or exceeds a predetermined threshold, indicating a good quality set of sampled image pairs. In some examples, the second image-to-image translation component 308 can determine that a value of a quality measure associated with the set of sampled image pairs falls below the predetermined threshold, indicating a less promising set of sampled image pairs.

Based on determining that the set of sampled image pairs is a less promising set, the second image-to-image translation component 308 determines that one or more of the model parameters or settings should be updated, and that a new set of (real image, transformed output image) pairs should be generated. The second image-to-image translation component 308 can automatically update the one or more model parameters based on a predetermined parameter search or update strategy. In some examples, the second image-to-image translation component 308 can elicit and/or receive updated values for the one or more parameters via the UI of the trained image-to-image diffusion model. In some examples, the second image-to-image translation component 308 can determine that a generated set of (real image, transformed output image) pairs is of good quality, and therefore can be used for training a student model, such as a specialized image-to-image translation model.

In some examples, the specialized image-to-image translation model can correspond to a fully convolutional neural network (CNN). The second image-to-image translation component 308 can train such a CNN using the set of (real image, transformed output image) pairs as training data. For example, the CNN can be trained to minimize a perceptual loss between its predictions on the real images and the corresponding transformed output images in the training data. The use of real images as part of the training data can help the specialized image-to-image translation model achieve enhanced performance in cases where synthetic images would differ from the realistic appearance of images taken, for example, using device cameras. The reduced size of the trained specialized image-to-image translation model and/or its reduced inference time computational requirements enable it to be run in near real-time on a variety of computing devices. In some examples, the trained specialized image-to-image translation model can be post-processed, for example using a neural architecture search procedure (e.g., automated channel pruning), to ensure that the resulting version of the model (e.g., a more light-weight model, etc.) runs on a variety of devices with a variety of storage and/or processing power characteristics.

In some examples, the second image-to-image translation component 308 is deployed to and/or executed by one or more of the components of the interaction server system 110 (e.g., the API server 122, interaction servers 124, etc.). In some examples, the specialized image-to-image translation model (e.g., the CNN) is deployed to, trained at and/or executed by the respective one or more of the components of the interaction server system 110. In some examples, the second image-to-image translation component 308 is deployed to and/or executed by a computer client device 118 (e.g., at a user system 102). In some examples, the specialized image-to-image translation model (e.g., the CNN) is deployed to, trained at and/or executed by a computer client device 118 (e.g., at the user system 102). In some examples, due to the reduced size and computational requirements and/or its mobile friendly nature, the specialized image-to-image translation model (e.g., the CNN) can be deployed or transmitted to and/or executed by other client devices, including user devices such as mobile device 114, head-wearable apparatus 116, and so forth.

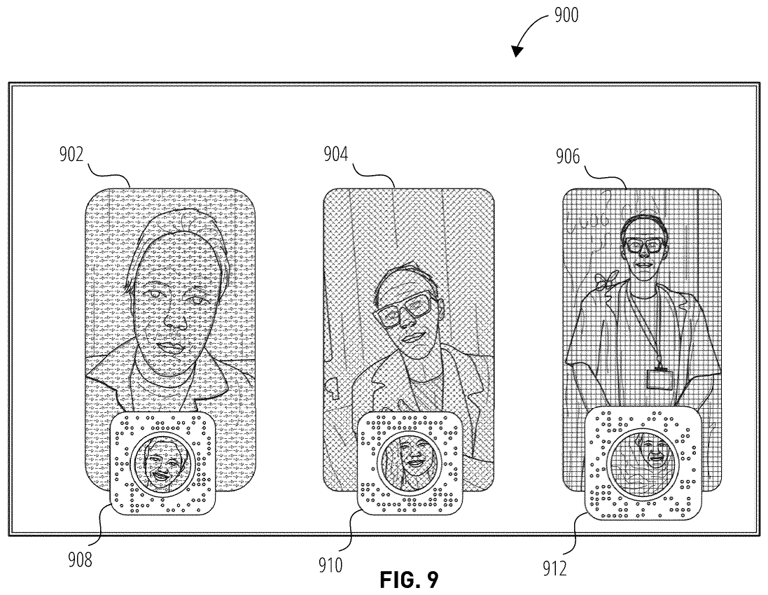

Given a transformation of interest and/or a trained specialized image-to-image model implementing the transformation of interest, the AR experience generation component 310 can use the trained specialized image-to-image model to automatically create a digital effect such as an AR experience associated with the transformation of interest. In some examples, AR experience generation component 310 creates the AR experience and/or its associated data, incorporates it into an AR experience bundle, and makes it available for deployment and/or execution on a client device (e.g., stores it on and/or transmits it for execution to a user device such as a mobile device 114, head-wearable apparatus 116, computer client device 118, and so forth). For example, a model file (e.g., a .dnn file) associated with the trained specialized image-to-image model can be integrated for use in a digital effect (e.g., an image filter or image transformation feature, AR experience, etc.) corresponding to the transformation of interest (e.g., a “Pixel Art” digital effect, etc.). A user can use the digital effect (e.g., AR experience) on a user device (e.g., a mobile device) to automatically transform one or more user photos using the transformation of interest (see, e.g., FIG. 9-FIG. 11). In some examples, a user can create content with the digital effect applied thereto on their user device, and then store the content or share it with other users of the interaction system 100 of FIG. 1. In some examples, the AR experience generation component 310 is executed by one or more of the components of the interaction server system 110 (e.g., the API server 122, a server of the interaction servers 124, etc.). In some examples, the AR experience generation component 310 is executed at a user system 102 (e.g., at a computer client device 118, mobile device 114, head-wearable apparatus 116, and so forth).

### Example Method for Generating Paired Source-Target Prompts

FIG. 4 is a flowchart illustrating a method 400 for generating pairs of aligned source prompts and target prompts, according to some examples, as implemented by the AR experience generation system 202. In some examples, method 400 can be implemented by the image pairs generation component 304. In some examples, the method 400 can be implemented by a dedicated pair prompt generation component that functions as a component of the AR experience generation system 202, a component of the image pairs generation component 304, or shares functionality with either component. In some examples, the dedicated pair prompt generation component can be separate from either the image pairs generation component 304 or the AR experience generation system 202 as a whole, being accessible via an API. In the following, the method 400 is discussed as being implemented by the image pairs generation component 304 for illustrative purposes only.

Given a transformation of interest of a set of transformations and/or an associated edit prompt (e.g., “Pixel Art”), the image pairs generation component 304 automatically generates a transformation-specific set of (source prompt, target prompt) pairs. Method 400 starts at opening block 402.

At operation 404, the image pairs generation component 304 samples attributes that characterize potential source images, such as for example a person's age/gender/facial expression/etc., content and/or aspect of an image's background, and so forth. In some examples, the AR experience generation system 202 can thus use a subset of a schema characterizing source images, while in others all relevant attributes in the schema can be used. Given a selected set of image attributes, the image pairs generation component 304 can sample or select a value for each attribute of the selected attributes.

Given the set of selected image attributes, each attribute being associated with at least one sampled value, the image pairs generation component 304 can generate a source prompt (see operation 406). In some examples, the prompt can be generated by populating a predefined template. In some examples, the image pairs generation component 304 can provide the selected attributes, selected values and one or more conditions related to the type, length, or other aspects of the desired output to a text generation module, powered by example by a large language model (LLM), or by another suitable language model or text generation model. The text generation module can generate a source prompt (for further image generation) that incorporates all the necessary attributes and values while satisfying the conditions. An example of a source prompt can be seen in Table 1 below. It will be appreciated that the relevant/desired features of the person would be included where indicated (e.g., [APPEARANCE FEATURE A] would specify a specific feature and/or feature value of the desired appearance while [APPEARANCE FEATURE B] would specify some other feature and/or feature value of the desired appearance.

Given the generated source prompt and/or selected attributes and/or values used to generate it, the image pairs generation component 304 can generate, at operation 408, a corresponding target prompt that reflects key content in the source prompt while including aspects representative of the transformation of interest. An example of a target prompt structure can be seen in Table 1 below. As it can be seen, certain attributes of the person's appearance and their corresponding values present in the source prompt are included in the target prompt, while style attributes (e.g., “low-res,” “blocky,” “pixel art style,” etc.) are used to indicated desired aspects of a transformation from a photorealistic image to a pixel art image. In some examples, a corresponding target prompt can be generated in the context of the transformation being associated with one or more reference images. In such a case, the corresponding target prompt is generated to include a token corresponding to the relevant LoRA model, as described with reference to FIG. 3.

TABLE 1
Example paired prompts based on the “Pixel Art” edit prompt

| | |
|---|---|
| Source prompt | A photorealistic portrait of a person with [APPEARANCE FEATURE |
| | A], [APPEARANCE FEATURE B], [APPEARANCE FEATURE C], |
| | [APPEARANCE FEATURE D], wearing shirt, shocked with wide eyes |
| | and gaping mouth, lake in the background, natural skin texture, |
| | elegant, 4k textures, sharp focus, soft cinematic light, photorealism, |
| | 24 mm, highly detailed, intricate |
| Target prompt | A pixel-art of a person with [APPEARANCE FEATURE |
| | A], [APPEARANCE FEATURE B], [APPEARANCE FEATURE C], |
| | [APPEARANCE FEATURE D], wearing shirt, shocked with wide eyes |
| | and gaping mouth, lake in the background, low-res, blocky, pixel art |
| | style, 8-bit graphics |

At operation 410, the image pairs generation component 304 outputs the generated (source prompt, target prompt) pair. In some examples, the image pairs generation component 304 can repeat one or more of operations 404 to 410 to generate a set of (source prompt, target prompt) pairs for further use, as seen for example in FIG. 5. The method concludes at closing loop block 412.

### Example Method for Generating Paired Source-Target Images

FIG. 5 is a flowchart illustrating a method 500 for generating aligned image pairs, according to some examples, as implemented by the AR experience generation system 202 via the image pairs generation component 304. The method 500 starts at opening loop block 502.

At operation 504, the image pairs generation component 304 generates an synthetic image using a source prompt (e.g., a NL prompt) and the image generation pipeline 302. For illustrative purposes, the image generation pipeline 302 is discussed herein as corresponding to a text-to-image diffusion pipeline. The source prompt is retrieved from a set of (source prompt, target prompt) pairs generated, for example, as described at least in FIG. 4.

Given the image generated at operation 504, the image pairs generation component 304 extracts, at operation 506, one or more image aspects, such as: face cut-out information corresponding to a face detected in the image, depth map of a subset of the image or of the full image, semantic segmentation mask associated with the detected face, contour map associated with the full image, face contour map determined by combining (e.g., multiplying) the contour map and the face mask for the detected face, face keypoints, body keypoints, and so forth. In some examples, the AR experience generation system 202 focuses on transformations related to person faces or selfies. In such cases, should the image pairs generation component 304 determine that the image does not include a face, the image pairs generation component 304 repeats the image generation of operation 504 and further proceeds from there.

Given the source prompt, target prompt, extracted image aspects and the image generation pipeline 302, the image pairs generation component 304 generates, at operation 508, a (source image, target image) pair of aligned images. The source image is generated by running the image generation pipeline 302 with inputs including the source prompt, a set of conditions corresponding to one or more of the extracted image aspects, and/or a random noise tensor. The target image is generated by running the image generation pipeline 302 with inputs including the target prompt, the same set of conditions, and/or the same random noise tensor. The extracted conditions are accepted and/or processed by one or more components such as an IP-Adapter component, a ControlNet component, and/or other auxiliary modules include in the image generation pipeline 302, as detailed at least in FIG. 3 and FIG. 16.

Given the (source image, target image) pair generated at operation 508, the image pairs generation component 304 applies, at operation 510, one or more post-processing operations that further increase the alignment between the generated source image and target image. In some examples, the image pairs generation component 304 applies a color correction procedure to the target image, for example ensuring that skin tone or color associated with a person represented in the initial source image is preserved. In some examples, the image pairs generation component 304 adjusts one or more landmarks in the target image to match the position of the one or more landmarks in the initial source image, ensuring that key structure is preserved post transformation. For example, by adjusting facial landmarks, the image pairs generation component 304 ensures that the facial expression of a person in the source image remains the same or highly similar in the corresponding target image. In some examples, given a post-processed target image derived based on one or more of the above post-processing steps, the image pairs generation component 304 applies to it a pass of a diffusion pipeline (e.g., corresponding to the image generation pipeline 302) in an image-to-image translation configuration with reduced denoising strength. In some examples, the image pairs generation component 304 examines (source image, target image) pairs (either initial ones, generated at operation 508, or pairs resulting after one or more of the above post-processing steps) to determine whether one or more alignment criteria are met. If a number of alignment criteria that exceeds a predetermined threshold are met, the relevant (source image, target image) pair is retained as part of a final (source image, target image) set; otherwise the pair is filtered out. Example alignment criteria can include: a measure indicating the degree of position alignment between sets of facial landmarks for the source image and, respectively, target image; perceptual similarity metrics computed based on the source image and target image, and so forth. An alignment criterion is met if the corresponding measure and/or metrics has a determined value transgressing a predetermined threshold.

At operation 512, the image pairs generation component 304 returns or outputs the set of final (source image, target image) pairs computed at operation 510, for further use by the AR experience generation system 202. The method 500 concludes at closing loop block 514.

### Example AR Experience Generation Method

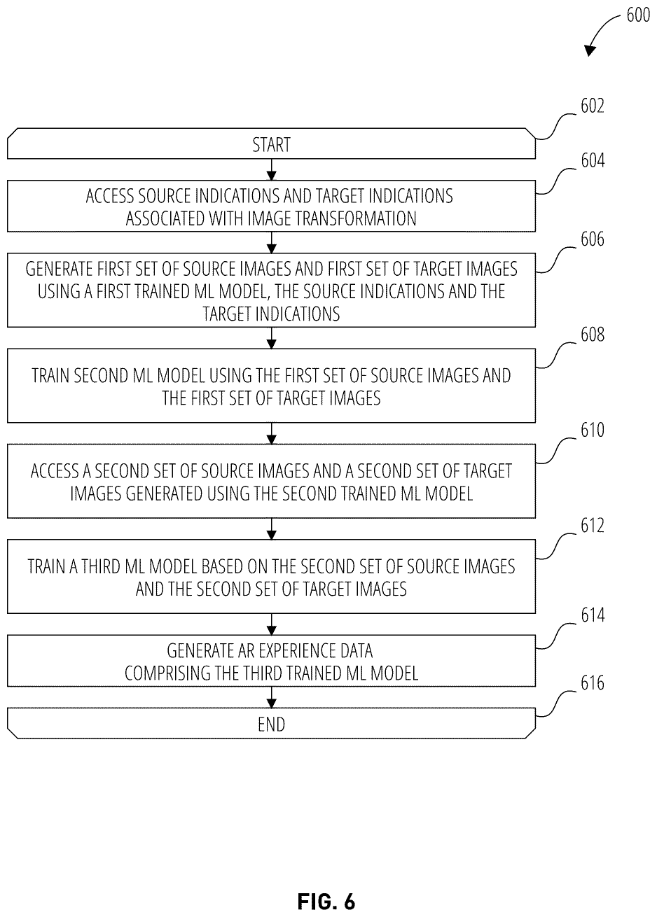

FIG. 6 is a flowchart illustrating an AR experience generation method 600, according to some examples, as implemented by the AR experience generation system 202. The method starts at opening block 602.

At operation 604, the AR experience generation system 202 accesses a set of source indications and a set of target indications associated with an image transformation. In some examples, the source indications and/or target indications are retrieved from storage. In some examples, the source indications and/or target indications are automatically generated based on an image transformation indication associated with the transformation. In some examples, the set of source indications corresponds to a set of source prompts and the set of target indications corresponds to a set of target prompts, the sets of source prompts and target prompts being generated as described in reference to FIG. 4.

At operation 606, the AR experience generation system 202 generates a first set of source images and first set of target images using a first trained machine learning (ML) model, the set of source indications, the set of target indications and/or the image transformation indication. In some examples, the first trained ML model can comprise a text-to-image diffusion pipeline.

At operation 608, the AR experience generation system 202 trains a second ML model to generate a target image corresponding to a source image based on the first set of source images and the first set of target images. In some examples, the second ML model can comprise an image-to-image diffusion model.

At operation 610, the AR experience generation system 202 accesses a second set of source images and a second set of target images, at least the second set of target images being generated using the second trained ML model. In some examples, the second set of source images corresponds to a set of real images. In some examples, the second set of target images is generated by running the second trained model on each image in the second set of source images.

At operation 612, the AR experience generation system 202 trains a third ML model to generate an additional target image corresponding to an additional source image based on the second set of source images and the second set of target images. In some examples, the third ML model corresponds to or comprises an image-to-image translation model in the form of a fully convolutional neural network (CNN).

At operation 614, the AR experience generation system 202 automatically generates augmented reality (AR) experience data comprising the third trained ML model.

### Examples of Source-Target Image Pairs

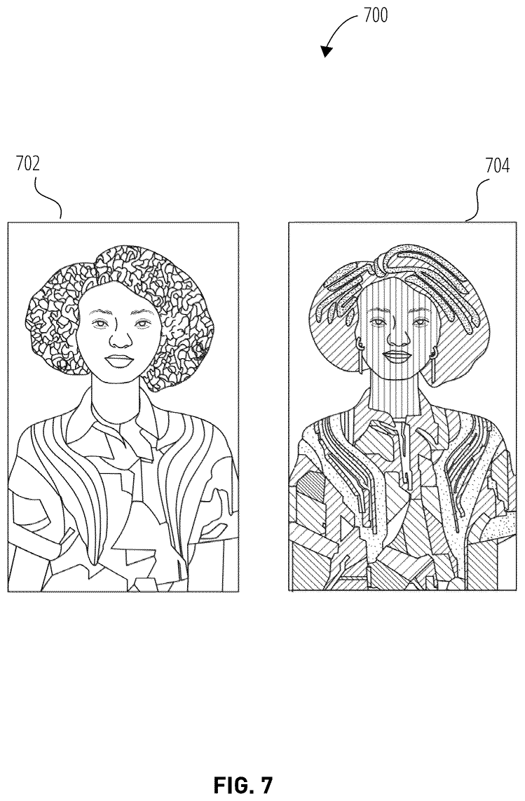

FIG. 7 is an illustration 700 of a (source image, target image) pair, according to some examples, as generated by the AR experience generation system 202. Source image 702 and target image 704 are generated by the image pairs generation component 304 via the image generation pipeline 302, as described in detail at least in FIG. 5. Source image 702 corresponds to a synthetic image. Target image 704 corresponds to an target image aligned with the source image, the target image being representative of a transformed version of the source image given a pixel art transformation associated with a “Pixel Art” edit prompt.

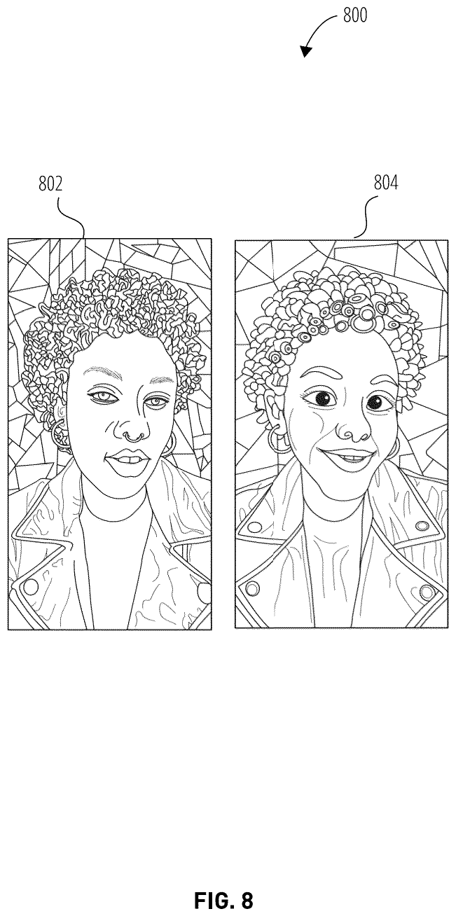

FIG. 8 is an illustration 800 of a (source image, target image) pair, according to some examples, as generated by the AR experience generation system 202. As described in FIG. 3, the AR experience generation system 202 trains, via the first image-to-image translation component 306, an intermediate image-to-image diffusion model based on aligned image pairs for one or more transformations. Given a transformation of interest (e.g., pixel art), the second image-to-image translation component 308 uses the trained image-to-image diffusion model as a teacher model in a teacher-student distillation setting. Given a photorealistic source image 802, the second image-to-image translation component 308 runs the trained image-to-image diffusion model on the source image 802, using input information indicating the transformation of interest to be executed by the trained image-to-image diffusion model (see details in FIG. 3). The resulting transformed image is target image 804.

As described with reference to FIG. 3, the second image-to-image translation component 308 uses a set of (source image, target image) pairs generated as above to train a transformation-specific, mobile friendly image-to-image translation model represented, for example, by a CNN.

### Examples of Image Transformations

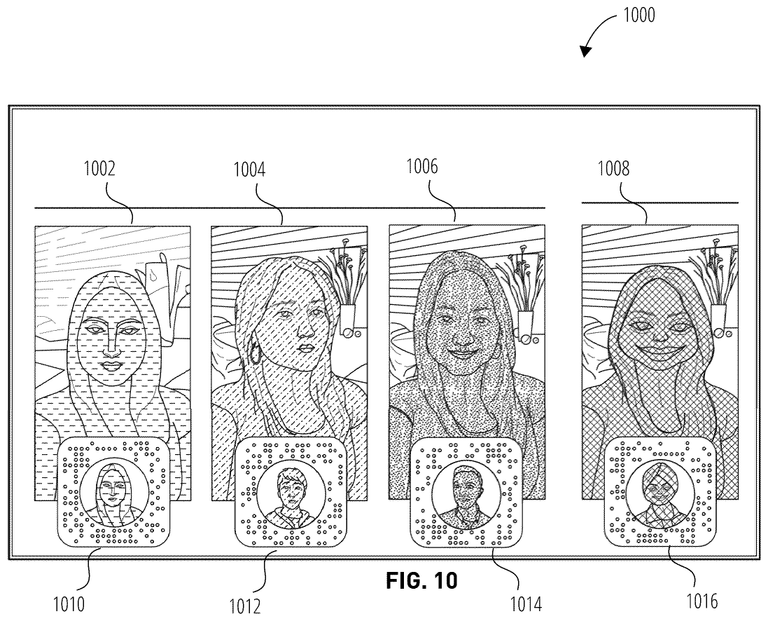

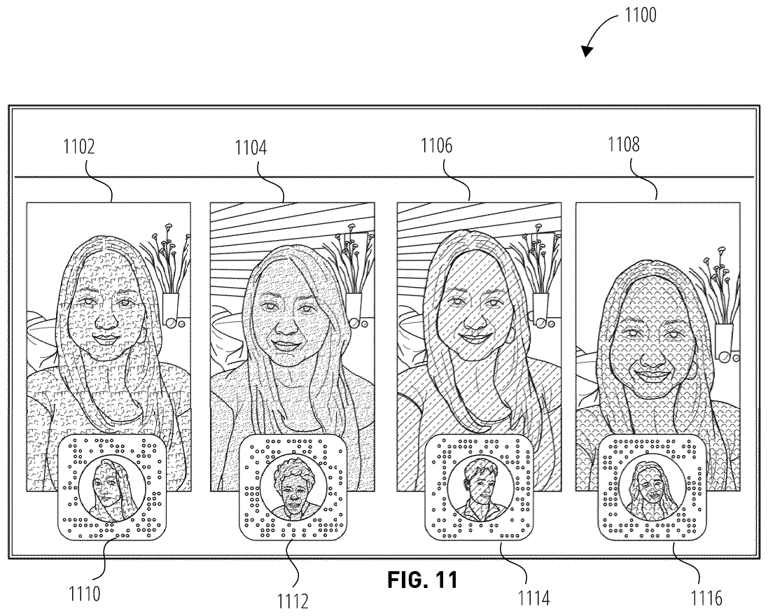

FIG. 9, FIG. 10 and FIG. 11 correspond to illustrations 900, 1000 and 1100 of image transformations, respectively, according to some examples. FIG. 9 includes three images 902, 904 and 906 illustrating three different styles based on work examples of an artist collaborating with the provider of the interaction system 100. FIG. 9 also includes images 908, 910, 912 that showcase the appearance of digital effects or AR experiences (e.g., available in the context of the interaction system 100) corresponding to the styles in 902, 904 and 906. In some examples, a user can select, while using a mobile device 114 (e.g., a device executing the interaction client 104), an example digital effect or AR experience to be applied to an input image or feed of interest. In some examples, upon the selection of a digital effect or AR experience incorporated in an AR bundle, the mobile device 114 executes a trained transformation-specific image-to-image translation model that is part of the corresponding AR experience data for the AR experience and AR experience bundle. As described at least in FIG. 3, such a transformation-specific image-to-image translation model was previously trained, for example, by the second image-to-image translation component 308 and then used by the AR experience generation component 310 to generate the AR experience as part of the AR experience bundle. In some examples, the AR experience bundle including the AR experience data, such as the trained transformation-specific image-to-image translation model, is stored locally (e.g., on the mobile device 114), while in others the AR experience bundle can be retrieved from a server (e.g., of the interaction server system 110). After executing (e.g., running) the transformation-specific image-to-image translation model, the mobile device 114 can display an output image or feed corresponding to the input image or input feed being modified, in near real-time, based on the selected image transformation or style (as seen in images 902, 904 or 906). In some examples, the user can thus create, on a user device such as a mobile device 114, content augmented by the application of such a digital effect and/or AR experience (e.g., transformed photos, etc.), store the augmented content on the user device and/or remotely on a server (e.g., of the interaction server system 110), and/or optionally share the augmented content with other users of the interaction system 100.

FIG. 10 includes images 1002, 1004 and 1006 illustrating portrait styles (e.g., transformations) based on Cubist and/or Symbolist paintings, among others, while image 1008 illustrates a style specific to the provider of the interaction system 100. FIG. 10 also includes images 1010, 1012, 1014, and 1016 that showcase the appearance of digital effects or AR experiences corresponding to the styles in images 1002-1008. FIG. 11 includes images 1102, 1104, 1106 and 1108 illustrating respective portrait styles (e.g., transformations based on English Renaissance, Expressionism, Neo Impressionism, and so forth). FIG. 11 also includes images 1110, 1112, 1114, 1116 that showcase the appearance of digital effects or AR experiences corresponding to the styles in images 1102-1108.

### Data Architecture

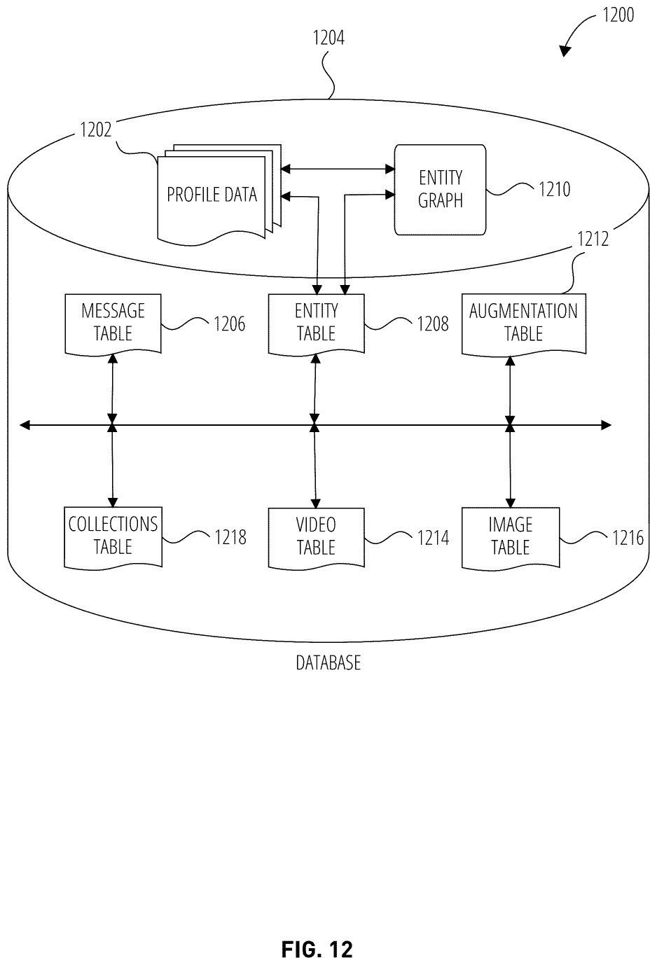

FIG. 12 is a schematic diagram illustrating data structures 1200, which may be stored in the database 1204 of the interaction server system 110, according to certain examples. While the content of the database 1204 is shown to comprise multiple tables, it will be appreciated that the data could be stored in other types of data structures (e.g., as an object-oriented database).

The database 1204 includes message data stored within a message table 1206. This message data includes, for any particular message, at least message sender data, message recipient (or receiver) data, and a payload. Further details regarding information that may be included in a message, and included within the message data stored in the message table 1206 are described below with reference to FIG. 12.

An entity table 1208 stores entity data, and is linked (e.g., referentially) to an entity graph 1210 and profile data 1202. Entities for which records are maintained within the entity table 1208 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 1210 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 1208. Such privacy settings may be applied to all types of relationships within the context of the interaction system 100, or may selectively be applied to certain types of relationships.

The profile data 1202 stores multiple types of profile data about a particular entity. The profile data 1202 may be selectively used and presented to other users of the interaction system 100 based on privacy settings specified by a particular entity. Where the entity is an individual, the profile data 1202 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 1202 for the group may similarly include one or more avatar representations associated with the group, in addition to the group name, members, and various settings (e.g., notifications) for the relevant group.

The database 1204 also stores augmentation data, such as overlays or filters, in an augmentation table 1212. The augmentation data is associated with and applied to videos (for which data is stored in a video table 1214) and images (for which data is stored in an image table 1216).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 1216 includes augmented reality content items (e.g., corresponding to applying “lenses” or augmented reality experiences). An augmented reality content item may be a real-time special effect and sound that may be added to an image or a video.

A collections table 1218 stores data regarding collections of messages and associated image, video, or audio data, which are compiled into a collection (e.g., a story or a gallery). The creation of a particular collection may be initiated by a particular user (e.g., each user for which a record is maintained in the entity table 1208). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 1214 stores video data that, in some examples, is associated with messages for which records are maintained within the message table 1206. Similarly, the image table 1216 stores image data associated with messages for which message data is stored in the entity table 1208. The entity table 1208 may associate various augmentations from the augmentation table 1212 with various images and videos stored in the image table 1216 and the video table 1214.

### Data Communications Architecture

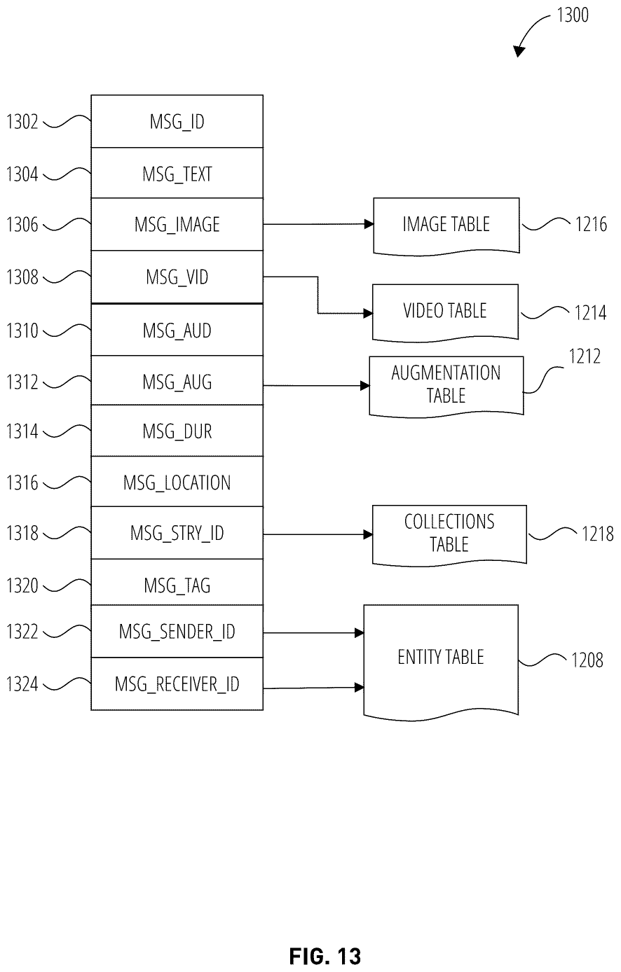

FIG. 13 is a schematic diagram illustrating a structure of a message 1300, according to some examples, generated by an interaction client 104 for communication to a further interaction client 104 via the interaction servers 124. The content of a particular message 1300 is used to populate the message table 1206 stored within the database 1204, accessible by the interaction servers 124. Similarly, the content of a message 1300 is stored in memory as “in-transit” or “in-flight” data of the user system 102 or the interaction servers 124. A message 1300 is shown to include the following example components:
Message identifier 1302: a unique identifier that identifies the message 1300.
Message text payload 1304: text, to be generated by a user via a user interface of the user system 102, and that is included in the message 1300.
Message image payload 1306: image data, captured by a camera component of a user system 102 or retrieved from a memory component of a user system 102, and that is included in the message 1300. Image data for a sent or received message 1300 may be stored in the image table 1216.
Message video payload 1308: video data, captured by a camera component or retrieved from a memory component of the user system 102, and that is included in the message 1300. Video data for a sent or received message 1300 may be stored in the image table 1216.
Message audio payload 1310: audio data, captured by a microphone or retrieved from a memory component of the user system 102, and that is included in the message 1300.
Message augmentation data 1312: augmentation data (e.g., filters, stickers, or other annotations or enhancements) that represents augmentations to be applied to message image payload 1306, message video payload 1308, or message audio payload 1310 of the message 1300. Augmentation data for a sent or received message 1300 may be stored in the augmentation table 1212.
Message duration parameter 1314: parameter value indicating, in seconds, the amount of time for which content of the message (e.g., the message image payload 1306, message video payload 1308, message audio payload 1310) is to be presented or made accessible to a user via the interaction client 104.
Message geolocation parameter 1316: geolocation data (e.g., latitudinal and longitudinal coordinates) associated with the content payload of the message. Multiple message geolocation parameter 1316 values may be included in the payload, each of these parameter values being associated with respect to content items included in the content (e.g., a specific image within the message image payload 1306, or a specific video in the message video payload 1308).
Message story identifier 1318: identifier values identifying one or more content collections (e.g., “stories” identified in the collections table 1218) with which a particular content item in the message image payload 1306 of the message 1300 is associated. For example, multiple images within the message image payload 1306 may each be associated with multiple content collections using identifier values.
Message tag 1320: each message 1300 may be tagged with multiple tags, each of which is indicative of the subject matter of content included in the message payload. For example, where a particular image included in the message image payload 1306 depicts an animal (e.g., a lion), a tag value may be included within the message tag 1320 that is indicative of the relevant animal. Tag values may be generated manually, based on user input, or may be automatically generated using, for example, image recognition.
Message sender identifier 1322: an identifier (e.g., a messaging system identifier, email address, or device identifier) indicative of a user of the user system 102 on which the message 1300 was generated and from which the message 1300 was sent.
Message receiver identifier 1324: an identifier (e.g., a messaging system identifier, email address, or device identifier) indicative of a user of the user system 102 to which the message 1300 is addressed.

The contents (e.g., values) of the various components of message 1300 may be pointers to locations in tables within which content data values are stored. For example, an image value in the message image payload 1306 may be a pointer to (or address of) a location within an image table 1216. Similarly, values within the message video payload 1308 may point to data stored within an image table 1216, values stored within the message augmentation data 1312 may point to data stored in an augmentation table 1212, values stored within the message story identifier 1318 may point to data stored in a collections table 1218, and values stored within the message sender identifier 1322 and the message receiver identifier 1324 may point to user records stored within an entity table 1208.

### Machine Architecture

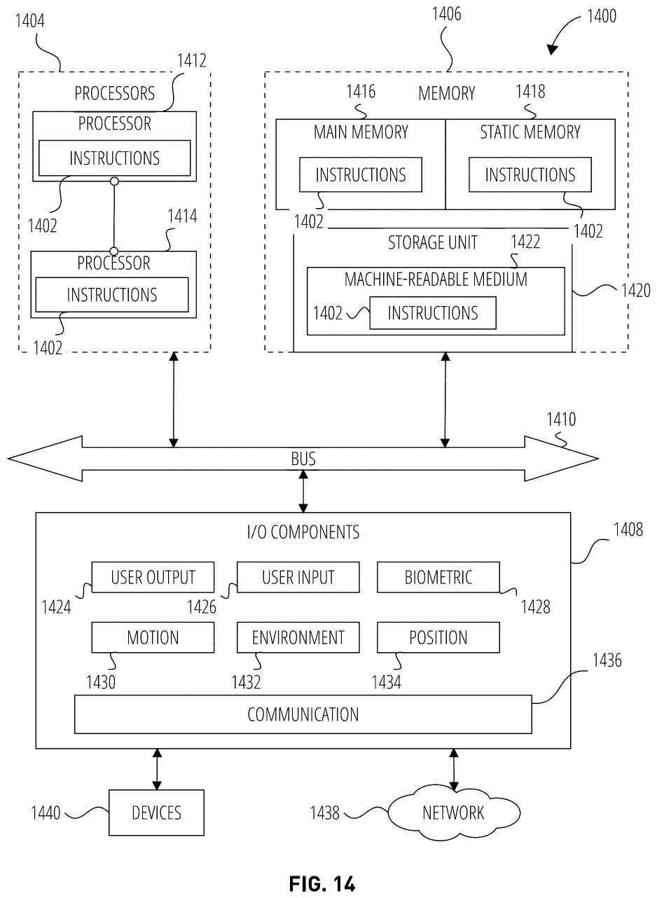

FIG. 14 is a diagrammatic representation of the machine 1400 within which instructions 1402 (e.g., software, a program, an application, an applet, an app, or other executable code) for causing the machine 1400 to perform any one or more of the methodologies discussed herein may be executed. For example, the instructions 1402 may cause the machine 1400 to execute any one or more of the methods described herein. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. The machine 1400, for example, may comprise the user system 102 or any one of multiple server devices forming part of the interaction server system 110. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1408, which may be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1412 and a processor 1414 that execute the instructions 1402. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, both accessible to the processors 1404 via the bus 1410. The main memory 1416, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 may include biometric components 1428, motion components 1430, environmental components 1432, or position components 1434, among a wide array of other components. For example, the biometric components 1428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1430 include acceleration sensor components (e.g., accelerometer), gravitation sensor components, rotation sensor components (e.g., gyroscope).

The environmental components 1432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1436 operable to couple the machine 1400 to a network 1438 or devices 1440 via respective coupling or connections. For example, the communication components 1436 may include a network interface component or another suitable device to interface with the network 1438, In further examples, the communication components 1436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1440 may be another machine or any of a wide variety of peripheral devices (e.g., a peripheral device coupled via a USB).

Moreover, the communication components 1436 may detect identifiers or include components operable to detect identifiers. For example, the communication components 1436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1436, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1438, using a transmission medium, via a network interface device (e.g., a network interface component included in the communication components 1436) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1440.

### Software Architecture

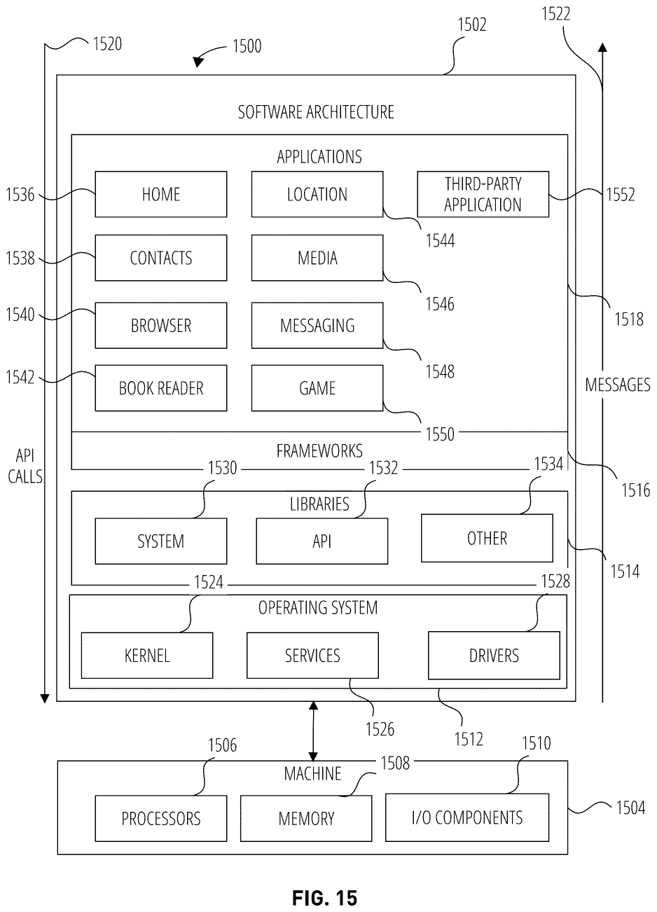

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematic functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a contacts application 1538, a browser application 1540, a book reader application 1542, a location application 1544, a media application 1546, a messaging application 1548, a game application 1550, and a broad assortment of other applications such as a third-party application 1552. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1552 can invoke the API calls 1520 provided by the operating system 1512 to facilitate functionalities described herein.

FIG. 16 is a block diagram showing a machine-learning program 1600 according to some examples. The machine-learning programs 1600, also referred to as machine-learning algorithms or tools, are used as part of the AR experience generation system 202 system described herein.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1608 in order to make data-driven predictions or decisions expressed as outputs or assessments (e.g., assessment 1616). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1600 supports two types of phases, namely a training phases 1602 and prediction phases 1604. In training phases 1602, supervised learning, unsupervised or reinforcement learning may be used. For example, the machine-learning program 1600 (1) receives features 1606 (e.g., as structured or labeled data in supervised learning) and/or (2) identifies features 1606 (e.g., unstructured or unlabeled data for unsupervised learning) in training data 1608 In prediction phases 1604, the machine-learning program 1600 uses the features 1606 for analyzing query data 1612 to generate outcomes or predictions, as examples of an assessment 1616.

In the training phase 1602, feature engineering is used to identify features 1606 and may include identifying informative, discriminating, and independent features for the effective operation of the machine-learning program 1600 in pattern recognition, classification, and regression. In some examples, the training data 1608 includes labeled data, which is known data for pre-identified features 1606 and one or more outcomes. Each of the features 16066 may be a variable or attribute, such as individual measurable property of a process, article, system, or phenomenon represented by a data set (e.g., the training data 1608). Features 1606 may also be of different types, such as numeric features, strings, and graphs, and may include one or more of content 1618, concepts 1620, attributes 1622, historical data 1624 and/or user data 1626, merely for example.

In training phases 1602, the machine-learning program 1600 uses the training data 1608 to find correlations among the features 1606 that affect a predicted outcome or assessment 1616

With the training data 1608 and the identified features 1606, the machine-learning program 1600 is trained during the training phase 1602 at machine-learning program training 1610. The machine-learning program 1600 appraises values of the features 1606 as they correlate to the training data 1608. The result of the training is the trained machine-learning program 1614 (e.g., a trained or learned model).

Further, the training phases 1602 may involve machine learning, in which the training data 1608 is structured (e.g., labeled during preprocessing operations), and the trained machine-learning program 1614 implements a relatively simple neural network 1628 (or one of other machine learning models, as described herein) capable of performing, for example, classification and clustering operations. In other examples, the training phase 1602 may involve deep learning, in which the training data 1608 is unstructured, and the trained machine-learning program 1614 implements a deep neural network 1628 that is able to perform both feature extraction and classification/clustering operations.

A neural network 1628 generated during the training phase 1602, and implemented within the trained machine-learning program 1614, may include a hierarchical (e.g., layered) organization of neurons. For example, neurons (or nodes) may be arranged hierarchically into a number of layers, including an input layer, an output layer, and multiple hidden layers. The layers within the neural network 1628 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1628 may also be one of a number of different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN) or related architectures such as U-Net architecture or MobileNet/MobileNetV2, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), a Transformer Network, merely for example.

During prediction phases 1604 the trained machine-learning program 1614 is used to perform an assessment. Query data 1612 is provided as an input to the trained machine-learning program 1614, and the trained machine-learning program 1614 generates the assessment 1616 as output, responsive to receipt of the query data 1612.

In some examples, the trained machine-learning program 1614 may be a generative artificial intelligence (AI) model. Generative AI is a term that may refer to any type of artificial intelligence that can create new content from training data 1608. For example, generative AI can produce text, images, video, audio, code, or synthetic data similar to the original data but not identical.

Some of the techniques that may be used in generative AI are:
1. Convolutional Neural Networks (CNNs): CNNs may be used for image recognition and computer vision tasks. CNNs may, for example, be designed to extract features from images by using filters or kernels that scan the input image and highlight important patterns.
2. Recurrent Neural Networks (RNNs): RNNs may be used for processing sequential data, such as speech, text, and time series data, for example. RNNs employ feedback loops that allow them to capture temporal dependencies and remember past inputs.
3. Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
4. Diffusion models: Diffusion models may be used, for example, for image generation or image-to-image translation tasks. Diffusion models may include text-to-image diffusion models, image-to-image diffusion models, speech-to-image diffusion models, sketch-to-image diffusion models, multi-modal input diffusion models, and so on. Diffusion models may progressively convert random noise into images. Diffusion models may include an encoder network and a decoder network. For example, text-to-image diffusion models may iteratively refine random noise into a coherent images matching a text description. A text-to-image diffusion model may include a text encoder network that processes text descriptions provided, for example, as natural language prompts into a format used to guide the image generation process. The text-to-image diffusion model may include an image decoder network that uses this encoded text description information in the context of the diffusion process that “denoises” input random noise to convert it into an image that aligns with and/or matches the text description. An image-to-image diffusion model enabled for instruction-based image editing may correspond to a specialized ML architecture that can transform input images according to text instructions or prompts while maintaining key structural elements of the original image. Diffusion models enabled for instruction-based image editing build upon the denoising capabilities of generic diffusion models and are optimized for controlled image transformation tasks as an alternative to, or in addition to, image generation from scratch. Diffusion models enabled for instruction-based image editing may incorporate text encoders to process editing instructions, use cross-attention mechanisms to align image features with textual descriptions, and/or implement conditioning controls to preserve desired image attributes during transformation. Examples of diffusion models enabled for instruction-based image editing include models that combine a U-Net backbone with transformer-based text encoders, models that incorporate control networks (ControlNet) for precise feature preservation, models that use image prompt adapters (IP-Adapter) to better handle visual references during editing, and so forth.
5. Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
6. Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data include predictions, translations, summaries or media content.

In some generative AI examples, the trained machine-learning program 1614 can be a Large Language Model (LLM). LLMs can perform tasks such as recognizing, translating, predicting, or generating text (or other content), and can be used for text classification, question answering, document summarization, text generation, as well as plan generation, code generation, prediction problems (e.g., predicting protein structures), and so forth. Examples of LLMs include GPT-3.5, GPT-4, Bard, Cohere, PaLM, Falcon, Claude, Llama, Orca, Phi-1, Jurassic and more.

In some generative AI examples, diffusion models can include Stable Diffusion, DALL-E, Google's Imagen or Parti models, Midjourney models, and so forth. In some examples, a diffusion pipeline (e.g., such as a text-to-image diffusion pipeline, an image-to-image diffusion pipeline, etc.) can include a diffusion model (e.g., a text-to-image diffusion model, an image-to-image diffusion model, etc.), as well as one or more control mechanisms or control architectures, such as a ControlNet neural network, an IP-Adapter mechanism, a Low-Rank Adaptation (e.g., LoRa) technique for model customization or fine-tuning, and so forth. For example, Stable Diffusion includes a U-Net architecture that serves as the backbone denoising network while transformer-based text encoders process and embed the textual instructions. In another example, Google's Imagen uses a T5 transformer encoder for text processing combined with a U-Net backbone. The U-Net structure is well-suited for maintaining spatial information during image transformations, while the transformer-based text encoders excel at understanding and encoding complex textual instructions that guide the editing process.

### EXAMPLES

Example 1 is a system comprising: at least one processor; and at least one memory component storing instructions that, when executed by the at least one processor, cause the at least one processor to perform operations comprising: accessing a set of source indications and a set of target indications associated with an image transformation; generating a first set of source images and first set of target images using a first trained machine learning (ML) model, the set of source indications and the set of target indications; training a second ML model to generate a target image corresponding to a source image based on the first set of source images and the first set of target images; accessing a second set of source images and a second set of target images, at least the second set of target images being generated using the second trained ML model; training a third ML model to generate an additional target image corresponding to an additional source image based on the second set of source images and the second set of target images; and automatically generating augmented reality (AR) experience data comprising the third trained ML model.

In Example 2, the subject matter of Example 1 includes, the operations further comprising generating the set of source indications and the set of target indications based on an image transformation indication associated with the image transformation.

In Example 3, the subject matter of Example 2 includes, wherein generating the set of source indications and the set of target indications further comprises: accessing a set of image attributes; generating a set of image attribute values corresponding to the set of image attributes; generating, using the set of image attributes and the set of image attribute values, the set of source indications; and generating, using the set of source indications and the image transformation indication, the set of target indications.

In Example 4, the subject matter of Examples 1-3 includes, wherein generating the first set of source images and the first set of target images further comprises: generating a sample source image using the first trained ML model and a source indication of the set of source indications; and extracting a set of image aspects based on the sample source image.

In Example 5, the subject matter of Example 4 includes, wherein generating the first set of source images and the first set of target images further comprises: generating an initial source image using the first trained ML model, a source indication of the set of source indications, the set of image aspects, and a noise tensor; and generating an initial target image using the first trained ML model, a target indication of the set of target indications corresponding to the source indication, the set of image aspects and the noise tensor.

In Example 6, the subject matter of Example 5 includes, wherein generating the first set of source images and the first set of target images further comprises applying one or more post-processing operations to the initial source image and the initial target image to generate a final source image and a final target image.

In Example 7, the subject matter of Example 6 includes, wherein the one or more post-processing operations comprise a color correction operation, landmark adjustment operation, or a diffusion pass operation.

In Example 8, the subject matter of Examples 1-7 includes, wherein the first trained ML model comprises a text-to-image diffusion model.

In Example 9, the subject matter of Examples 1-8 includes, wherein the first trained ML model uses one or more auxiliary ML models, the one or more auxiliary ML models comprising at least one of a control network (ControlNet) or an image prompt adapter (IP-Adapter) model.

In Example 10, the subject matter of Examples 2-9 includes, wherein the image transformation indication comprises a natural language (NL) description or a visual description, the visual description comprising a set of reference images associated with the image transformation.

In Example 11, the subject matter of Examples 2-10 includes, wherein training the second ML model is further based on the image transformation indication associated with the image transformation.

In Example 12, the subject matter of Examples 1-11 includes, wherein the second ML model comprises an image-to-image diffusion model enabled to execute instruction-based image editing.

In Example 13, the subject matter of Examples 1-12 includes, wherein: the second set of source images corresponds to a set of real images; and generating the second set of target images comprises running the second trained ML model on each image in the second set of source images.

In Example 14, the subject matter of Example 13 includes, receiving, via a user interface (UI) of the second trained ML model, user input indicating values of a set of parameters of the second ML model; and running the second trained ML model on each image in the second set of source images using the received values for the set of parameters of the second trained ML model.

In Example 15, the subject matter of Example 14 includes, receiving, via a user interface (UI) of the second trained ML model, user input associated with the second set of source images and the second set of target images; determining, based on the received user input, that a value of a quality measure associated with the second set of source images and the second set of target images transgresses a predetermined threshold; and upon determining the value of quality measure transgresses the predetermined threshold, generating an additional set of target images using the second trained ML model and an updated set of values for the set of parameters of the second trained ML model.

In Example 16, the subject matter of Examples 1-15 includes, wherein the third ML model is a convolutional neural network (CNN).

In Example 17, the subject matter of Example 16 includes, generating an adjusted ML model by adjusting a structure of the third ML model using a neural architecture search, the adjusted ML model being enabled to run on a plurality of devices comprising at least mobile devices.

In Example 18, the subject matter of Examples 1-17 includes, transmitting the AR experience data comprising the third trained ML model to a mobile device.

Example 19 is at least one non-transitory machine-readable medium including instructions that, when executed by processing circuitry, cause the processing circuitry to perform operations to implement of any of Examples 1-18.

Example 20 is an apparatus comprising means to implement of any of Examples 1-18.

Example 21 is a computer-implemented method to implement of any of Examples 1-18.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPUTER-READABLE STORAGE MEDIUM” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“NON-TRANSITORY COMPUTER-READABLE STORAGE MEDIUM” refers, for example, to a tangible medium that is capable of storing, encoding, or carrying the instructions for execution by a machine.

“SIGNAL MEDIUM” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“EPHEMERAL MESSAGE” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by soft ware (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“USER DEVICE” refers, for example, to a device accessed, controlled or owned by a user and with which the user interacts perform an action or interaction on the user device, including an interaction with other users or computer systems.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“TRAINING SET” and “TEST SET” in this context are understood in the context of typical ML model development. A development set is selected and properly split into train/validation/test sets. The training set may refer to a “train/validation” set. The test set may refer to a “test/evaluation” or “test/assessment” set. In some examples, properly splitting the development set takes into account temporal dependencies, for example corresponding to the time series nature of the event streams, or the tracked user behaviors.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
at least one processor; and
at least one memory component storing instructions that, when executed by the at least one processor, cause the at least one processor to perform operations comprising:
accessing a set of source indications and a set of target indications associated with an image transformation;
generating a first set of source images and first set of target images using a first trained machine learning (ML) model, the set of source indications and the set of target indications;
training a second ML model to generate a target image corresponding to a source image based on the first set of source images and the first set of target images;
accessing a second set of source images and a second set of target images, at least the second set of target images being generated using the second trained ML model;
training a third ML model to generate an additional target image corresponding to an additional source image based on the second set of source images and the second set of target images; and
automatically generating augmented reality (AR) experience data comprising the third trained ML model.

2. The system of claim 1, the operations further comprising generating the set of source indications and the set of target indications based on an image transformation indication associated with the image transformation.

3. The system of claim 2, wherein generating the set of source indications and the set of target indications further comprises:
accessing a set of image attributes;
generating a set of image attribute values corresponding to the set of image attributes;
generating, using the set of image attributes and the set of image attribute values, the set of source indications; and
generating, using the set of source indications and the image transformation indication, the set of target indications.

4. The system of claim 1, wherein generating the first set of source images and the first set of target images further comprises:
generating a sample source image using the first trained ML model and a source indication of the set of source indications; and
extracting a set of image aspects based on the sample source image.

5. The system of claim 4, wherein generating the first set of source images and the first set of target images further comprises:
generating an initial source image using the first trained ML model, a source indication of the set of source indications, the set of image aspects, and a noise tensor; and
generating an initial target image using the first trained ML model, a target indication of the set of target indications corresponding to the source indication, the set of image aspects and the noise tensor.

6. The system of claim 5, wherein generating the first set of source images and the first set of target images further comprises applying one or more post-processing operations to the initial source image and the initial target image to generate a final source image and a final target image.

7. The system of claim 6, wherein the one or more post-processing operations comprise a color correction operation, landmark adjustment operation, or a diffusion pass operation.

8. The system of claim 1, wherein the first trained ML model comprises a text-to-image diffusion model.

9. The system of claim 1, wherein the first trained ML model uses one or more auxiliary ML models, the one or more auxiliary ML models comprising at least one of a control network (ControlNet) or an image prompt adapter (IP-Adapter) model.

10. The system of claim 2, wherein the image transformation indication comprises a natural language (NL) description or a visual description, the visual description comprising a set of reference images associated with the image transformation.

11. The system of claim 2, wherein training the second ML model is further based on the image transformation indication associated with the image transformation.

12. The system of claim 1, wherein the second ML model comprises an image-to-image diffusion model enabled to execute instruction-based image editing.

13. The system of claim 1, wherein:
the second set of source images corresponds to a set of real images; and
generating the second set of target images comprises running the second trained ML model on each image in the second set of source images.

14. The system of claim 13, further comprising:
receiving, via a user interface (UI) of the second trained ML model, user input indicating values of a set of parameters of the second ML model; and
running the second trained ML model on each image in the second set of source images using the received values for the set of parameters of the second trained ML model.

15. The system of claim 14, further comprising:
receiving, via a user interface (UI) of the second trained ML model, user input associated with the second set of source images and the second set of target images;
determining, based on the received user input, that a value of a quality measure associated with the second set of source images and the second set of target images transgresses a predetermined threshold; and
upon determining the value of quality measure transgresses the predetermined threshold, generating an additional set of target images using the second trained ML model and an updated set of values for the set of parameters of the second trained ML model.

16. The system of claim 1, wherein the third ML model is a convolutional neural network (CNN).

17. The system of claim 16, further comprising generating an adjusted ML model by adjusting a structure of the third ML model using a neural architecture search, the adjusted ML model being enabled to run on a plurality of devices comprising at least mobile devices.

18. The system of claim 1, further comprising transmitting the AR experience data comprising the third trained ML model to a mobile device.

19. A computer-implemented method comprising:
accessing a set of source indications and a set of target indications associated with an image transformation;
generating a first set of source images and first set of target images using a first trained machine learning (ML) model, the set of source indications and the set of target indications;
training a second ML model to generate a target image corresponding to a source image based on the first set of source images and the first set of target images;
accessing a second set of source images and a second set of target images, at least the second set of target images being generated using the second trained ML model;
training a third ML model to generate an additional target image corresponding to an additional source image based on the second set of source images and the second set of target images; and
automatically generating augmented reality (AR) experience data comprising the third trained ML model.

20. A non-transitory computer-readable storage medium having stored thereon instructions that, when executed by at least one processor, cause the at least one processor to perform operations comprising:
accessing a set of source indications and a set of target indications associated with an image transformation;
generating a first set of source images and first set of target images using a first trained machine learning (ML) model, the set of source indications and the set of target indications;
training a second ML model to generate a target image corresponding to a source image based on the first set of source images and the first set of target images;
accessing a second set of source images and a second set of target images, at least the second set of target images being generated using the second trained ML model;
training a third ML model to generate an additional target image corresponding to an additional source image based on the second set of source images and the second set of target images; and
automatically generating augmented reality (AR) experience data comprising the third trained ML model.
